(19) United States
(12) Patent Application Publication
(10) Pub. No.: US 2003/0093562 A1
(43) Pub. Date: May 15, 2003

(54) Efficient peer to peer discovery

(76) Inventor: Chandrashekar R. Padala, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/011,029

(22) Filed: Nov. 13, 2001

(51) Int. Cl. G06F 15/16

(52) U.S. Cl. 709/245; 709/227

(57) ABSTRACT

The invention provides an efficient name-to-address discovery system for multi-network peer-to-peer communications. Common zones are created between two or more network groups to share name-to-address resolution resources. By establishing relationships between the servers managing each network, address discovery may be implemented across the common zone formed by the networks. This permits address resolution for peer-to-peer communications across different networks without reliance on a higher-level server common to both networks. Another aspect of the invention permits authorization-based relationships between servers thus restricting access to peers on a given network as desired.

### FIELD

The invention pertains generally to networks. More particularly, the invention relates to a more efficient discovery method for peer-to-peer communications across different networks.

### BACKGROUND

In modern computer networks, computers (source computers) that seek to communicate with other computers (destination computers), also known as peer-to-peer communications, should be able to determine the address of the destination computer. Typically, a source computer has the name of the destination computer but does not have the destination address (binding information) necessary to communicate with the destination computer directly.

There are a few types of name-to-address resolution service models for networks supporting peer-to-peer communications. One such name-to-address resolution scheme uses a server to maintain a list of all peer contact or binding information (e.g., a name-to-address index), usually an Internet Protocol (IP) address. The disadvantage of this architecture is that it suffers from poor scalability and reliability. That is, as the network grows the list of peer addresses that is maintained becomes increasingly large. This inhibits efficient network communications. Because this approach relies on a server to maintain and provide peer addresses, this creates a large load on the server and exposes the network to a single point of failure. Additionally, delays in discovering new peers in the network is a source of unreliable communications.

One example of the server-centered name-to-address resolution service describe above is the World Wide Web (WWW) Domain Name Server (DNS) system.

Another service model relies solely on communications between peers to resolve peer names and contact binding information. That is, broadcast messages and/or other types of notification schemes may be employed to inform peers about contact binding information for other peers. This model, typically referred to as pure peer-to-peer approach, has the disadvantage of increasing network traffic and being less reliable as network traffic increases.

### BRIEF DESCRIPTION OF THE DRAWINGS

FIG. 1 is a block diagram illustrating a network architecture with a typical peer address discovery scheme.

FIG. 2 is a block diagram illustrating one embodiment of the multi-network name-to-address resolution aspect of the invention.

FIG. 3 is a block diagram illustrating one embodiment of multi-network name-to-address resolution relationships according to one aspect of the invention.

FIG. 4 is a block diagram illustrating various multi-network name-to-address resolution relationships at different hierarchical levels according to one embodiment of the invention.

FIG. 5 is a flow diagram illustrating one method of sharing name-to-address resolution resources across multiple networks according to one embodiment of the invention.

### DETAILED DESCRIPTION

In the following detailed description of the invention, numerous specific details are set forth in order to provide a thorough understanding of the invention. However, the invention may be practiced without these specific details. In other instances well known methods, procedures, and/or components have not been described in detail so as not to unnecessarily obscure aspects of the invention.

Throughout this description, the term ‘address’ generally refers to any contact or binding information necessary for a first peer to communicate with another peer. The term ‘peer’ generally refers to various devices including a processing device/unit, computer systems, and data storage devices. The term ‘server’ generally refers to any computer or device which manages, maintains, and/or facilitates communications to and/or from other computers. As employed in the description and claims, the term ‘name-to-address index’ is used interchangeably to generally refer to any address resolution resource that may be employed. Thus, the term ‘index’ should includes hash tables, look-up lists, and any other address resolution resource or method.

In the accompanying figures, dashed lines are often used to indicate communications between devices and do not necessarily indicate a physical interface or coupling. Also, the label for each device (block) appears boxed or framed within the device.

The invention provides a system, method, and device for quick and efficient peer-to-peer discovery (name-to-address resolution) across a multi-network.

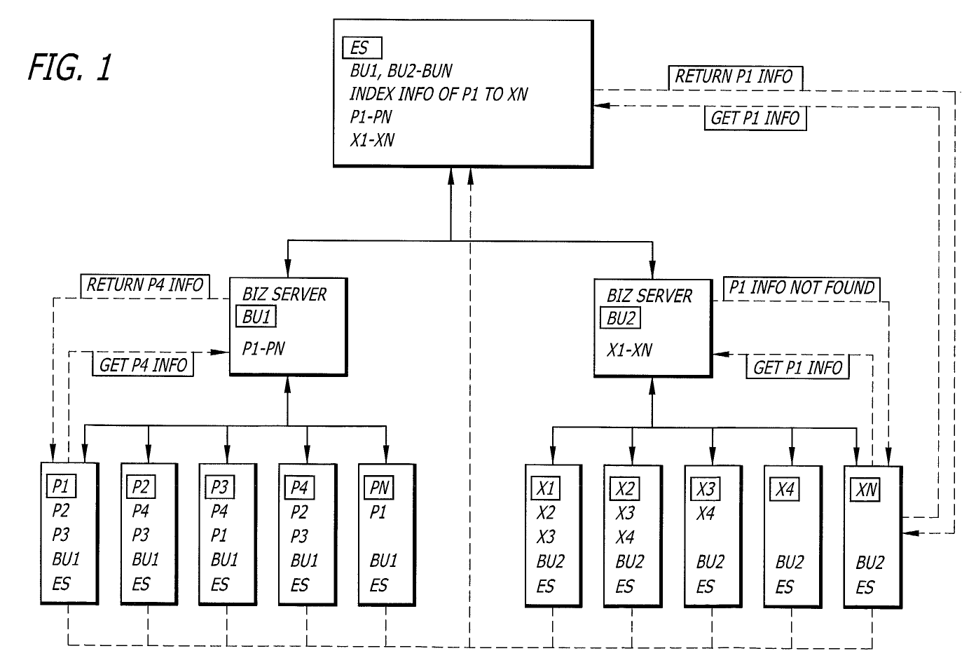

Referring to FIG. 1, one embodiment of a typical enterprise network is illustrated. An enterprise server (ES) serves as the host for name-to-address information for peers under it. In this illustration, the ES hosts the peer name-to-address list/index for two networks, business unit #1 (BU1) network and business unit #2 (BU2) network. Each network comprises one or more peers (e.g., P1, P2, P3, P4, and PN for the BU1 network and X1, X2, X3, X4, and XN for the BU2 network—where N denotes a positive integer). Each of the business unit servers (e.g., BU1 and BU2) typically maintains an index of local peer addresses. For example, BU1 maintains a list of the peer addresses for the peers in its network (e.g. P1-PN). Similarly, business unit server BU2 maintains the peer addresses for the peers in its local network (e.g. X1-XN).

Typically, a first peer that seeks to communicate with another peer in its network first obtains the address for the other peer. For example, in FIG. 1 if P1 wishes to communicate with P4 it first obtains its address from the business unit (BU1) server for the local network. Since BU1 is the address server for the local network, it maintains the address for peer P1 through PN, including P4. Thus, BU1 will be able to provide P1 with the address for P4. Upon receipt of the P4 address, P1 will be able to communicate (send messages) with P4.

In one implementation, once a peer obtains the address information for another peer it stores it for future reference. Thus, a peer may maintain and index or list of one or more addresses. For example, P1 maintains a list of other peer addresses including, P2 and P3. Similarly, peer P2 maintains the addresses for peers P3 and P4, peer P3 maintains the addresses for peers P4 and P1, peer P4 maintains the addresses for P2 and P3, and PN maintains the address for P1.

In one embodiment, a peer may save only the last n peer addresses of the peers with which it communicated, where n is a positive integer. Peers may also maintain other addresses such as the local business unit server (e.g. BU) and enterprise server (e.g. ES) to expedite network communications.

When a peer operating in a first network seeks to communicate with another peer operating in a second network it typically obtains the other peer's address from a server common to both networks. In a hierarchical network this means going up the hierarchy until a computer (server) is found which spans both networks. For example, when peer XN in the BU2 network seeks to communicate with peer P1 in the BU1 network, it first obtains its address. Peer XN first tries to obtain the address for P1 from its local server BU2. Since P1 is in another network, BU2 is unable to provide the address, and the request fails. Peer XN then goes up one level to the enterprise server ES and request the address for P1. Since ES acts as the name server host for peer addresses in both the BU1 and BU2 networks (it is common to both networks), it maintains address information for peers in both networks, including P1. Thus, ES would respond to XN's request with the address information for P1.

The address discovery system described above and illustrated in FIG. 1 has the disadvantage of relying on a single server ES to permit peer-to-peer communications across two networks (e.g. BU1 network and BU2 network). As noted above, reliance on a single server for inter-network communications causes traffic congestion and is susceptible to a single point of failure.

One aspect of the invention provides a scheme to permit peer-to-peer communications between networks without reliance on a higher level server. A relationship is established between servers, each in different networks, to permit address information discovery or exchange (name-to-address resolution) for peers in one or both of the networks.

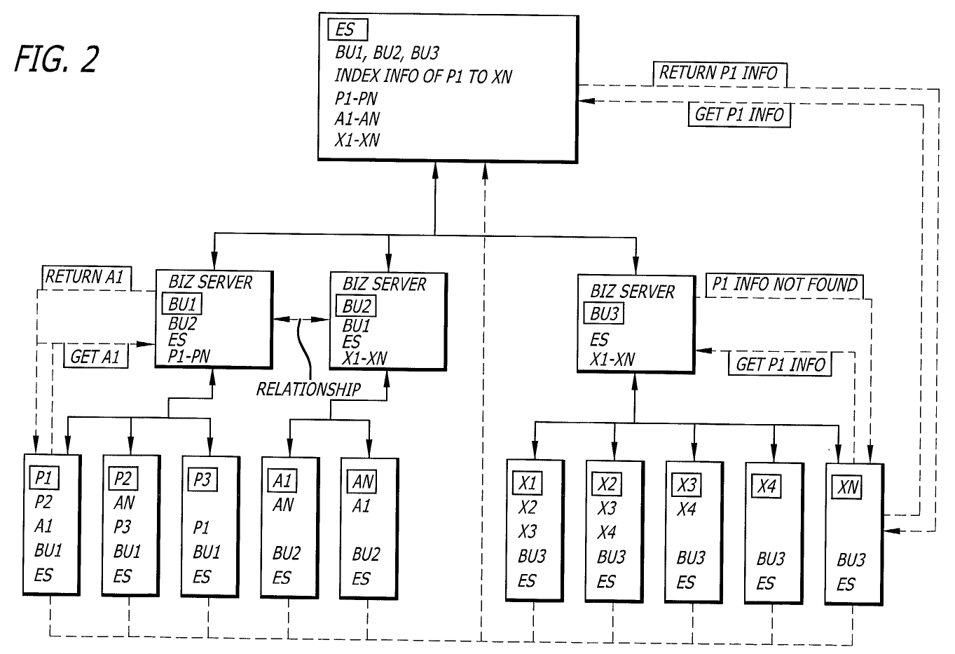

Referring to FIG. 2, a group of networks each managed by a business server (e.g. BU1, BU2, and BU3) and all served by a single higher level server (e.g. ES) is illustrated. Like the network describe in FIG. 1, if peer XN in network BU3 seeks to communicate with P1 in network (BU1), it contacts the common higher level server ES to obtain its address.

According to one embodiment of the invention, a relationship is established between business unit servers BU1 and BU2 such that a name-to-address resolution resources can be shared from one network to the other may be established without reliance on the higher level server (ES). For example, if peer P1 in the BU1 network seeks to communicate with peer A1 in the BU2 network it requests its address from its local server BU1 as usual. Because a relationship has been established between servers BU1 and BU2 (indicated by the direct bidirectional dashed line between the two servers), server B1 is able to query server B2 to obtain the address for A1 and return it to the requesting peer P1. Thus, P1 is able to establish peer-to-peer communications without relying on the enterprise server ES for cross-network address resolution.

Once a peer has obtained the address information for another peer, either within its local network or in another network, it may store such address for later reference.

The address sharing relationship between two or more servers may be characterized as creating a ‘common zone’ across multiple networks. Common zones generally refer to logical groups of two or more networks which at some level share address resolution/discovery information without relying on higher level or common servers to do so. As used herein, common servers are servers which are at a higher level in the server hierarchy and span both of the networks.

A common zone creates a transparent address discovery interface. From the perspective of a peer in a first network, peers on other networks appear to be ‘local’ since there is no need to contact a higher level server to obtain its address.

While the illustration in FIG. 2 depicts a common zone for peers of networks BU1 and BU2, common zone relationships are not limited to networks (or business units or servers) at the same hierarchical level. A common zone may be formed between multiple networks at the same hierarchical level or networks at different hierarchical levels. For example, business server BU1 may form a common zone relationship with a network operating under X3 (in network BU3) to share name-to-address information and expedite address resolution for peer-to-peer communications. Additionally, a local server (e.g. BU1) may establish multiple independent common zones with other servers.

Another aspect of the invention enables access protection and restricted access to the peers on a given network. Unlike the typical DNS hierarchical architecture, where peer access may not be individually restricted to certain peers, common zone access according to the invention permits authorization-based access to peers across multiple networks. Only peers in the same common zone (e.g., BU1 and BU2) are allowed to discover an address without having to query a higher level server common to both networks (e.g, ES). In one implementation, relationships between local servers (or servers within a common zone) permit restricting access to authorized peers only.

According to one implementation, a local server (e.g. BU2) may require a password or other authentication information before permitting an address discovery or sharing relationship to be established with another server (e.g. BU1) at the same hierarchical level. In other implementations, each server has a list of local servers with which it is allowed to share peer address information. A server may then check this list to determine if it may respond to an address information request from another server.

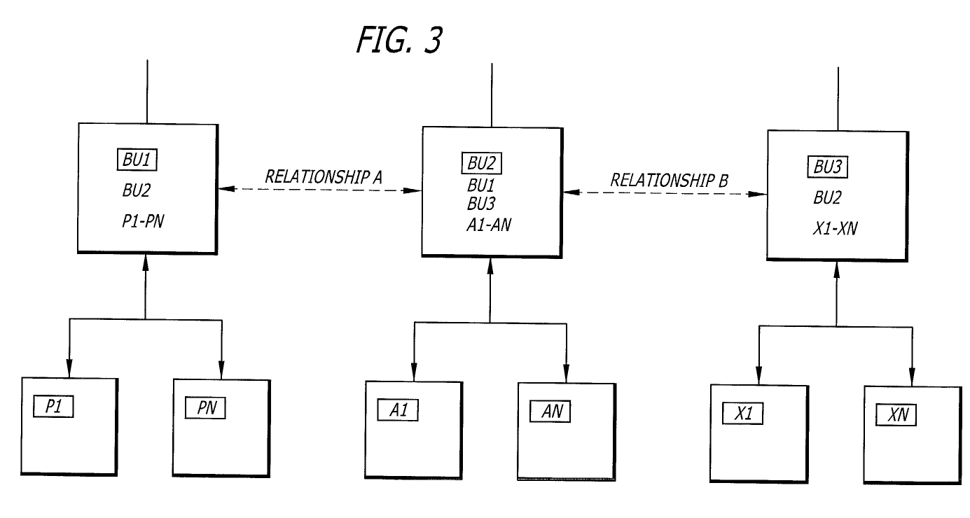

Derivative or indirect address resolution via the common zone relationships may be permitted or restricted depending on the implementation. Derivative or indirect address resolution may occur where one server maintains two common zone relationships with two other servers. For example, as illustrated in FIG. 3, server BU2 maintains a common zone relationship A with BU1 and a common zone relationship B with BU3. However, there is no direct common zone relationship between BU1 and BU3. Thus, BU2 may enable or prohibit common zone address discovery from BU1 to BU3 depending on the application.

In one implementation, server BU2 may deny an address request from a first peer in the BU1 network (e.g. P1) for an address of a second peer in the BU3 network (e.g. X1). In another implementation, server BU2 may provide the address information to a peer in the BU1 network (e.g. P1) seeking to communicate with a peer in the BU3 network (e.g. X1).

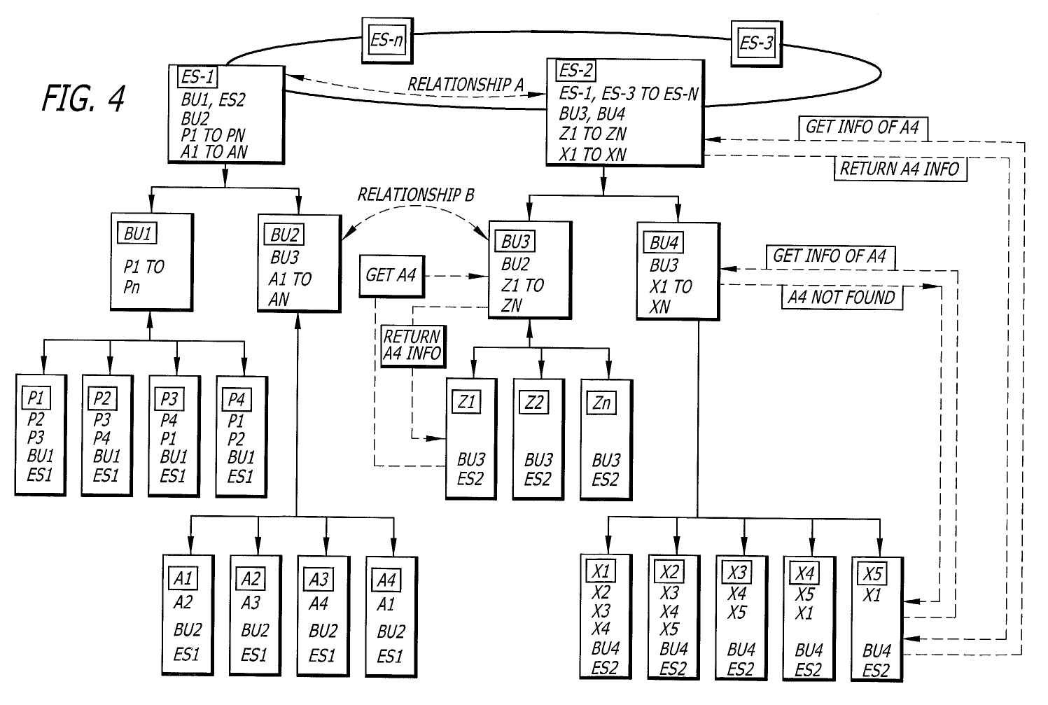

FIG. 4 illustrates yet another implementation of the invention where a common zone relationship is created across two enterprise networks. For example, a name-to-address sharing relationship may be created between ES1 and ES2 such that shared peer address discovery may be implemented. For instance, a peer X5 within network BU4 may seek to communicate with a peer A4 within network ES1. First, X5 requests A4's address from its local server BU4. If such request fails because BU4 does not have access to A4's address, X5 requests the address from the next higher level server ES2. Since ES2 has an address sharing relationship (relationship A) with ES1, it is able to obtain the address and respond to the request. Moreover, the address sharing relationship between ES1 and ES2 does not prevent other direct address sharing relationships from being established. For example, a direct address sharing relationship (relationship B) may be established between BU2 and BU3, each on different networks ES1 and ES2 respectively. Thus, when peer Z1 in network BU3 seeks to communicate with peer A4 in network BU2, then server BU3 may directly query server BU2 to obtain A4's address.

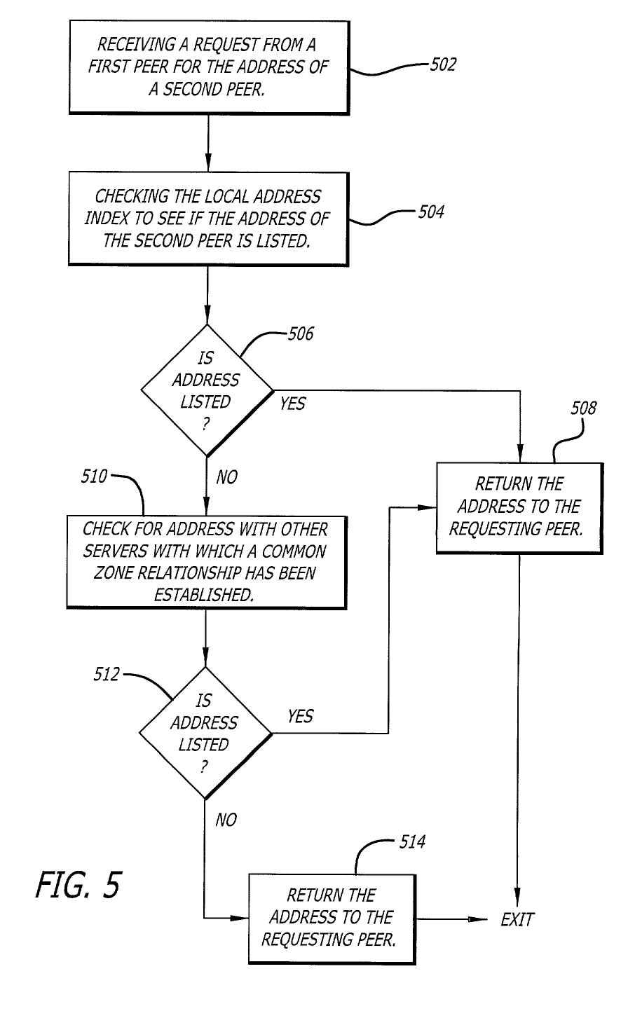

Referring to FIG. 5, according to one embodiment of the invention a server receives a request from a first peer for the binding information or address of a second peer 502. The server checks its local index to resolve the requested address 504. If the address is found 504, then the server returns the address to the first peer 508. If the address is not found 504, then the server directly checks with servers for other networks within its common zones 510 to try to resolve the address request. If the second peer belongs to one of the other networks within the common zone, the address will be resolved and returned to the first peer 512 and 508. If the address is not found, then the server returns an address invalid or address not found message to the first peer 514.

While certain exemplary embodiments have been described and shown in the accompanying drawings, it is to be understood that such embodiments are merely illustrative of and not restrictive on the broad invention, and that this invention should not be limited to the specific constructions and arrangements shown and described. Additionally, it is possible to implement the invention or some of its features in hardware, programmable devices, firmware, software or a combination thereof. The invention or parts of the invention may also be embodied in a processor readable storage medium or machine-readable medium such as a magnetic, optical, or semiconductor storage medium.

What is claimed is:

1. A system comprising:
a first network server to manage and maintain a name-to-address resolution index for a first network; and
a second network server to manage and maintain a name-to-address resolution index for a second network, the second server communicatively coupled to the first server and configured to share its name-to-address resolution index with the first server upon request by the first server to discover a peer address without reliance on a common name-to-address resolution server.

2. The system of claim 1 wherein the first and second network servers are at equivalent hierarchical levels.

3. The system of claim 1 wherein the first and second network servers have a common zone relationship.

4. The system of claim 3 wherein access authorization is required before a common zone is established.

5. The system of claim 3 further comprising:
a third network server to manage and maintain a name-to-address resolution index for a third network, wherein the second and third network servers have a common zone relationship.

6. The system of claim 5 wherein the second network server is also configured to search the name-to-address resolution index of the third network server upon an address request by the first network server.

7. The system of claim 1 wherein the first network server is also configured to share its name-to-address resolution index with the second network server upon request by the second network server.

8. A device comprising:
an input interface to receive messages; and
a processing unit coupled to the input interface, the processing unit to manage communications to at least one peer on a first network and configured to receive and respond to name-to-address resolution requests from the at least one peer on the first network, the processing unit configured to query other devices that manage communications on other networks if the processing unit is unable to resolve the name-to-address resolution request.

9. The device of claim 8 further comprising:
an output interface to couple the processing unit to the at least one peer on the first network.

10. The device of claim 8 wherein the processing unit responds to a name-to-address resolution request by sending the requested address if it is found, and sending an address not found reply if the address is not found.

11. The device of claim 8 being at an equivalent hierarchical level as the other network management device it queries if it is unable to resolve the requested address.

12. The device of claim 8 wherein the device establishes common zone relationships with the other devices it queries.

13. The device of claim 12 wherein the device provides access authorization before establishing a common zone.

14. A method comprising:
establishing a common zone relationship for name-to-address resolution sharing between two or more networks;
receiving a request from a first peer for the address of a second peer;
checking a local name-to-address index for the requested address of the second peer;
checking the common zone name-to-address index if the requested address is not found in the local name-to-address index; and
returning the requested address to the first peer if the address is found.

15. The method of claim 14 further comprising:
returning an indication that the requested address was not found to the first peer if the requested address is not found.

16. The method of claim 14 wherein establishing a common zone relationship requires authorization.

17. The method of claim 14 wherein derivative common zone name-to-address resolution is permitted.

18. A machine-readable medium comprising at least one instruction to resolve a peer address, which when executed by a processing unit, causes the processing unit to perform operations comprising:
establishing a common zone relationship for name-to-address resolution sharing between two or more networks;
receiving a request from a first peer for the address of a second peer;
checking a local name-to-address index for the requested address of the second peer;
checking the common zone name-to-address index if the requested address is not found in the local name-to-address index; and
returning the requested address to the first peer if the address is found.

19. The machine-readable medium of claim 18 further comprising:
returning an indication that the requested address was not found to the first peer if the requested address is not found.

20. The machine-readable medium of claim 18 wherein authorization is required to establish a common zone relationship.

21. The machine-readable medium of claim 18 wherein derivative common zone name-to-address resolution is provided.
